(19) United States
(12) Patent Application Publication
(10) Pub. No.: US 2024/0346318 A1
(43) Pub. Date: Oct. 17, 2024

(54) METHOD, APPARATUS, DEVICE AND MEDIUM FOR MANAGING MODEL BASED ON DISTANCE BETWEEN SAMPLES

(71) Applicant: Beijing Youzhuju Network Technology Co., Ltd., Beijing (CN)

(72) Inventors: Hao WU, Beijing (CN); Cheng Yang, Beijing (CN)

(21) Appl. No.: 18/504,220

(22) Filed: Nov. 8, 2023

(30) Foreign Application Priority Data
Nov. 8, 2022 (CN) 202211396127.0

(51) Int. Cl. G06N 3/084; G06N 3/094

(52) U.S. Cl. CPC G06N 3/084; G06N 3/094

(57) ABSTRACT

A method, apparatus, device, and medium for managing a model based on a distance between samples. In one method, a basic sample for training a contrastive learning model and a plurality of negative samples associated with the basic sample is obtained; a sequence of the plurality of negative samples is generated based on distances between the plurality of negative samples and the basic sample; the sequence of the plurality of negative samples is divided into a first set of negative samples and a second set of negative samples; an update parameter for updating the contrastive learning model is determined based on the basic sample, the first set of negative samples and a first weight of the first set of negative samples, and the second set of negative samples and a second weight of the second set of negative samples, the first weight is greater than the second weight.

### CROSS-REFERENCE TO RELATED APPLICATIONS

The present application claims priority to Chinese Patent Application No. 202211396127 0.0 filed on Nov. 8, 2022, and entitled “METHOD, APPARATUS, DEVICE, AND MEDIUM FOR MANAGING MODEL BASED ON DISTANCE BETWEEN SAMPLES”, the entirety of which is incorporated herein by reference.

### FIELD

Example implementations of the present disclosure generally relate to machine learning, and in particular, to a method, apparatus, device, and medium for managing a model based on a distance between samples.

### BACKGROUND

In self-supervised learning, manual labeling of samples is not required. Positive and negative samples corresponding to the samples can be constructed by modifying the samples. Furthermore, positive and negative samples can be used to train the contrastive learning model. In order to improve a performance of the contrastive learning model, it is expected to construct a large number of negative samples during the training process. However, different construction methods result in different difficulties for different negative samples, which makes the training effect of the model different when using different negative samples to train the contrastive learning model. At this time, how to consider the contribution of negative samples of different difficulties in the training process to improve the performance of the contrastive learning model has become an urgent problem to be solved.

### SUMMARY

In a first aspect of the present disclosure, a method for managing a model based on the distance between samples is provided. In this method, a basic sample for training a contrastive learning model and a plurality of negative samples associated with the basic sample is obtained; a sequence of the plurality of negative samples is generated based on distances between the plurality of negative samples and the basic sample; the sequence of the plurality of negative samples is divided into a first set of negative samples and a second set of negative samples, a first distance between a first negative sample in the first set of negative samples and the basic sample is less than a second distance between a second negative sample in the second set of negative samples and the basic sample; and an update parameter for updating the contrastive learning model is determined based on the basic sample, the first set of negative samples and a first weight of the first set of negative samples, and the second set of negative samples and a second weight of the second set of negative samples, the first weight is greater than the second weight.

In a second aspect of the present disclosure, an apparatus for managing a model based on a distance between samples is provided. The apparatus comprises: an obtaining module, configured to obtain a basic sample for training a contrastive learning model and a plurality of negative samples associated with the basic sample; a generating module, configured to generate a sequence of the plurality of negative samples based on a distance between the plurality of negative samples and the basic sample; a dividing module, configured to divide the sequence of the plurality of negative samples into a first set of negative samples and a second set of negative samples, a first distance between a first negative sample in the first set of negative samples and the basic sample being less than a second distance between a second negative sample in the second set of negative samples and the basic sample; and a determining module, configured to determine an update parameter for updating the contrastive learning model based on the basic sample, the first set of negative samples and a first weight of the first set of negative samples, and the second set of negative samples and a second weight of the second set of negative samples, the first weight being greater than the second weight.

In a third aspect of the present disclosure, an electronic device is provided. The electronic device comprises: at least one processing unit; and at least one memory coupled to the at least one processing unit and storing instructions to be executed by the at least one processing unit, the instructions, when executed by the at least one processing unit, causing the device to perform a method in the first aspect.

In a fourth aspect of the present disclosure, a computer readable storage medium is provided, having a computer program stored thereon, the computer program, when executed by a processor, performing a method in the first aspect.

It would be understood that the content described in the Summary section of the present disclosure is neither intended to identify key or essential features of implementations of the present disclosure, nor is it intended to limit the scope of the present disclosure. Other features of the present disclosure will be readily envisaged through the following description.

### BRIEF DESCRIPTION OF THE DRAWINGS

Through the detailed description with reference to the accompanying drawings, the above and other features, advantages, and aspects of respective implementations of the present disclosure will become more apparent. The same or similar reference numerals represent the same or similar elements throughout the figures, wherein:

FIG. 1 shows a schematic diagram of an example environment in which implementations of the present disclosure can be applied.

FIG. 2 shows a block diagram of a process of training a contrastive learning model according to a technical solution.

FIG. 3 shows a block diagram of a process for managing models based on a distance between samples according to some implementations of the present disclosure.

FIG. 4A shows a block diagram of a process for determining a basic sample and a negative sample according to some implementations of the present disclosure.

FIG. 4B shows a block diagram of a process for determining a basic sample and a negative sample according to some implementations of the present disclosure.

FIG. 5 shows a block diagram of a process for generating a noise data frame according to some implementations of the present disclosure.

FIG. 6 shows a block diagram of a process for generating a data frame in a negative sample according to some implementations of the present disclosure.

FIG. 7 shows a block diagram of a process for determining a sequence of a plurality of negative samples based on a distance between samples according to some implementations of the present disclosure.

FIG. 8 shows a flowchart of a method for managing models based on a distance between samples according to some implementations of the present disclosure.

FIG. 9 shows a block diagram of an apparatus for managing models based on a distance between samples according to some implementations of the present disclosure.

FIG. 10 shows an electronic device capable of implementing one or more implementations of the present disclosure.

### DETAILED DESCRIPTION

Implementations of the present disclosure will be described in more detail below with reference to the accompanying drawings. Although some implementations of the present disclosure are shown in the drawings, it would be understood that the present disclosure can be implemented in various forms and should not be interpreted as limited to the implementations described herein. On the contrary, these implementations are provided for a more thorough and complete understanding of the present disclosure. It would be understood that the drawings and implementations of the present disclosure are only for the purpose of illustration and are not intended to limit the scope of protection of the present disclosure.

In the description of implementations of the present disclosure, the term “comprising”, and similar terms should be understood as open inclusion, i.e., “comprising but not limited to”. The term “based on” should be understood as “at least partially based on”. The term “one implementation” or “the implementation” should be understood as “at least one implementation”. The term “some implementations” should be understood as “at least some implementations”. Other explicit and implicit definitions may also be comprised below.

It is understandable that the data involved in this technical proposal (comprising but not limited to the data itself, data obtaining, use, storage, or deletion) shall comply with the requirements of corresponding laws, regulations, and relevant provisions.

It is understandable that before using the technical solution disclosed in respective implementations of the present disclosure, users shall be informed of the type, using scope, and using scenario of personal information involved in the present disclosure in an appropriate way, and be authorized by users according to relevant laws and regulations.

For example, in response to receiving a proactive request from a user, prompt information is sent to the user to explicitly remind the user that a requested operation will require the obtaining and use of personal information of the user, so that the user may independently choose, according to the prompt information, whether to provide personal information to electronic devices, applications, servers or storage media and other software or hardware that perform operations of the technical solution of the present disclosure.

As an optional but non-limiting implementation, in response to receiving a proactive request from a user, the way of sending prompt information to the user may be, for example, a popup window, in which the prompt information may be presented in the form of text. In addition, the popup window may further carry a selection control for the user to choose “agree” or “disagree” to provide personal information to electronic devices.

It is understandable that the above process of notifying and obtaining user authorization is only for the purpose of illustration and does not imply any implementations of the present disclosure. Other ways, to satisfy the requirements of relevant laws and regulations, may also be applied to implementations of the present disclosure.

As used herein, the term “in response to” is to represent a state in which a corresponding event occurs or a condition is satisfied. It will be understood that the timing of the subsequent action performed in response to the event or a condition may not be strongly correlated with the time when the event occurs or the condition is satisfied. For example, in some cases, the subsequent action may be performed immediately when the event occurs or the condition is satisfied; in other cases, the subsequent action may be performed after a period after the event occurs or the condition is satisfied.

### Example Environment

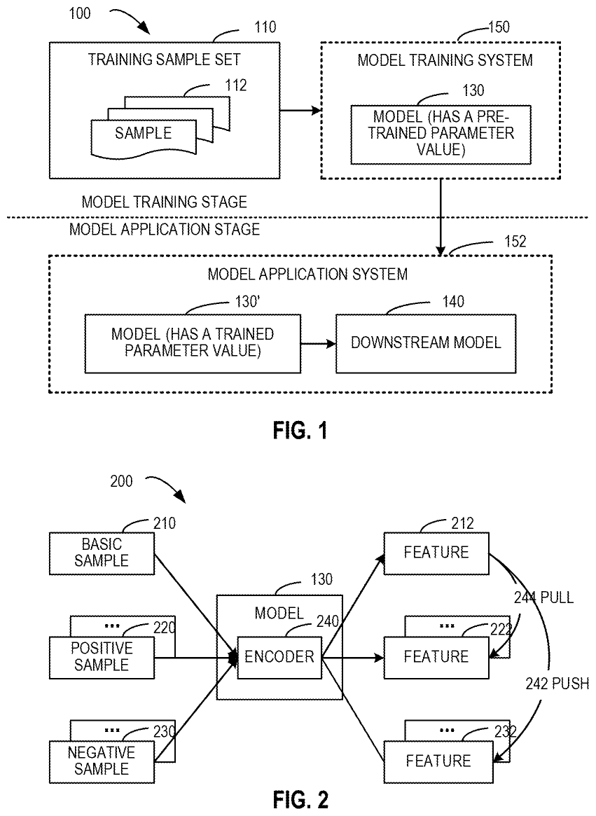

FIG. 1 shows a block diagram of an example environment 100 in which implementations of the present disclosure can be implemented. In the environment 100 of FIG. 1, it is desirable to train and use such a machine learning model (i.e., a contrastive learning model, abbreviated as model 130). The model is configured for a variety of application environments, e.g., for identifying similarities in videos, etc. As shown in FIG. 1, the environment 100 comprises a model training system 150 and a model application system 152. The upper part of FIG. 1 shows a process of a model training phase, and the lower part shows a process of a model application phase. Prior to training, a parameter value of the model 130 may have an initial value or may have a pre-trained parameter value obtained through a pre-training process. The model 130 may be trained via forward propagation and backward propagation, during which the parameter value of the model 130 may be updated and adjusted. A model 130′ may be obtained after training is complete. At this point, the parameter value of the model 130′ has been updated, and based on the updated parameter value, the model 130 may be used to implement prediction tasks during the model application phase.

During the model training phase, the model 130 may be trained with the model training system 150, based on a training sample set 110 comprising a plurality of samples 112. In contrastive learning, positive and negative samples may be constructed respectively with the plurality of samples 112, and the training process may be performed iteratively with a large number of samples. After training is completed, the model 130 may comprise knowledge associated with tasks to be processed. During the model application phase, the model 130′ (at this time, the model 130′ has a trained parameter value) may be called with the model application system 152. Further, a downstream model 140 may be called after the model 130′ to perform specific tasks.

In FIG. 1, the model training system 150 and the model application system 152 may comprise any computing system having computing power, such as various computing devices/systems, terminal devices, servers, etc. Terminal devices may involve any type of mobile terminal, fixed terminal, or portable terminal, comprising a mobile phone, a desktop computer, a laptop computer, a notebook computer, a netbook computer, a tablet computer, a media computer, a multimedia table, or any combination thereof, comprising accessories and peripherals of these devices or any combination thereof. Servers comprise but are not limited to a mainframe, an edge computing node, a computing device in a cloud environment, etc.

It should be understood that the components and arrangements in the environment 100 shown in FIG. 1 are merely examples, and a computing system suitable for implementing the example implementations described herein may comprise one or more different components, other components, and/or different arrangements. For example, although shown as separate, the model training system 150 and the model application system 152 may be integrated into the same system or device. Implementations of the present disclosure are not limited in this regard. Example implementations of the model training and the model application will continue to be described respectively below with reference to the accompanying drawings.

For the sake of description, only video processing is used as the application environment of the contrastive learning model in the present disclosure. The contrastive learning model can be used to perform video self-supervision tasks. For example, a video sequence set to be used as training samples may be obtained, and training samples can be constructed with respective video sequences in the video sequence set.

FIG. 2 shows a block diagram 200 of a process of training a contrastive learning model according to a technical solution. As shown in FIG. 2, a basic sample 210 can be determined from a video, and a positive sample 220 can be generated by modifying the basic sample 210. Further, a negative sample 230 can be obtained from the same video or other videos where the basic sample 210 is located. The basic sample 210 and positive sample 220 can be determined as a positive sample pair, and the basic sample 210 and negative sample 230 can be determined as a negative sample pair to train the model 130. During the training process, an encoder 240 in the model 130 can output features of the basic sample 210, positive sample 220, and negative sample 230, i.e., features 212, 222, and 232, respectively. As shown by arrow 244, the model 130 can be trained in the direction of pulling closer the distance between features 212 and 222; as shown by arrow 242, the model 130 can be trained in the direction of pushing farther the distance between features 212 and 232. The training process can be iteratively performed with a large number of positive and negative sample pairs.

Various technical solutions have been provided for constructing positive and negative samples. For example, a sample from the same video can be determined as a positive sample. In a BE technical solution, videos other than the positive samples can be directly determined as negative samples. In a Pace technical solution, the sampling frequency of videos other than positive samples can be adjusted (i.e., variable speed, for example, the sampling frequency can be adjusted from 0.25 seconds per frame to 0.5 seconds per frame, or other values), and the adjusted video can be determined as a negative sample. In an RSPNet technical solution, the sampling frequency of videos of positive samples can be adjusted, and the adjusted video can be determined as a negative sample.

At this time, a negative sample can come from the same video where the basic sample 210 is from (referred to as an inside-video negative sample) or can come from different videos where the basic sample 210 is from (abbreviated as an inter-video negative sample). Positive and negative sample pairs can be created with positive and negative samples generated through the above methods, and then the training process can be performed. However, differences in construction methods result in different difficulties for different negative samples, which causes the training effect of the model different when using different negative samples to train the contrastive learning model. At this point, how to consider the contribution of a negative sample of different difficulties in the training process to improve the performance of the contrastive learning model has become an urgent problem to be solved.

### Summary Description of the Model Training Process

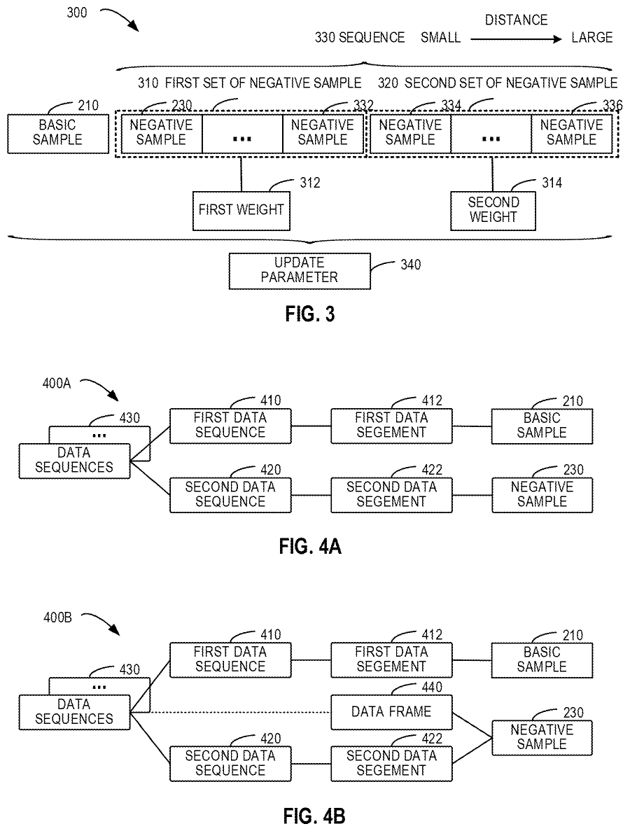

In order to at least partially address the drawbacks described above, a method for managing models based on a distance between samples is provided. A summary of an example implementation according to the present disclosure is described with reference to FIG. 3, which shows a block diagram 300 of a process for managing models based on a distance between samples according to some implementations of the present disclosure. As shown in FIG. 3, the basic sample 210 for training a contrastive learning model and a plurality of negative samples associated with the basic sample 210 can be obtained.

A sequence 330 of the plurality of negative samples can be determined based on a distance between the plurality of negative samples and the basic sample 210. Specifically, features of respective samples can be determined separately with the encoder 240 of the contrastive learning model. Further, the distance between the features of the two samples can be used as the distance between the two samples. As shown in FIG. 3, the sequence 330 comprises the plurality of negative samples 230, . . . , 332, 334, . . . , 336 arranged in descending order of distance.

Furthermore, the sequence 330 of the plurality of negative samples can be divided into a first set of a negative sample 310 and a second set of a negative sample 320. Here, a first distance between a first negative sample in the first set of negative samples 310 and the basic sample 210 is less than a second distance between a second negative sample in the second set of negative samples 320 and the basic sample 210. In other words, the respective negative samples in the first set of negative samples 310 is more similar to the basic sample 210 than the respective negative samples in the second set of negative samples 320. That is, compared to the second set of negative samples 320, the first set of negative samples 310 is more difficult to distinguish, so the first set of negative samples 310 can be referred to as difficult negative samples, and the second set of negative samples 320 can be referred to as simple negative samples.

According to an example implementation of the present disclosure, in order to distinguish the contribution of negative samples of different difficulties to the contrastive learning model, different weights can be assigned to two sets of negative samples. For example, a first weight 312 can be assigned to the first set of negative samples 310, and the second weight 314 can be assigned to the second set of negative samples 320. Here, the first weight 312 can be greater than the second weight 314 to indicate that the first set of negative samples 310 is a difficult negative sample.

Furthermore, based on the basic sample 210, the first set of negative samples 310, the first weight 312, the second set of negative samples 320, and the second weight 314, the update parameter for updating the contrastive learning model can be determined. In this way, semantic knowledge in difficult negative samples can be considered more during the training process, so that the trained contrastive learning model can distinguish difficult samples in a more accurate way and thus improve the recognition accuracy.

### Detailed Description of the Model Training Process

A summary of determining the first set of negative samples 310 and the second set of negative samples 320 based on a distance between samples has been described, and how to obtain respective samples will be described below. According to an example implementation of the present disclosure, a plurality of data sequences may exist for use as training data, and basic samples and negative samples may be determined respectively from the plurality of data sequences. FIG. 4A shows a block diagram 400A of a process for determining the basic sample 210 and the negative sample 230 according to some implementations of the present disclosure.

As shown in FIG. 4A, a plurality of data sequences 430 may comprise a first data sequence 410 and a second data sequence 420, the two data sequences may respectively comprise a plurality of data frames. A first data segment 412 may be selected from the first data sequence 410 and may be used as the basic sample 210. The first data segment 412 may comprise a portion of the data frames in the plurality of data frames in the first data sequence 410. The first data segment 412 may have a predetermined length, assuming that the first data sequence comprises N (positive integer) data frames, and the first data segment 412 may comprise n (positive integer) data frames (n<N).

Subsequently, a second data segment 422 may be selected from the second data sequence 420 in a similar way, and the second data segment 422 may be taken as a negative sample. The first data segment 412 and the second data segment 422 may have the same length (e.g., comprising n data frames). In the application environment of video processing, the data sequence in FIG. 4A may be a video sequence, alternatively and/or additionally, the data sequence may comprise sequences in other formats. For example, in the context of audio processing applications, the data sequences may comprise audio sequences. In other application scenarios, the data sequence may also comprise sequences such as thermal image sequences, temperature sequences, humidity sequences, or other monitored parameters.

The basic sample 210 and the inter-video negative sample 230 can be determined separately in a simple and efficient way with the example implementation of the present disclosure. It will be understood that although the foregoing only schematically shows determining one negative sample associated with the basic sample 210, the plurality of negative samples can be determined in a similar way. for example, a plurality of different negative samples can be selected from different locations in the second data sequence 420.

It will be understood that FIG. 4A only schematically shows a simple example for generating the negative sample 230 to which, alternatively and/or additionally, noise may be added to the negative sample in order to improve the robustness of the machine learning model. It will be understood that noise here may comprise both factors of appearance and sampling frequency (e.g., a playing speed of a video). For example, for appearance, data from other data frames may be introduced into respective video frames in the negative sample 230. For another example, for sampling frequency, frame extraction or frame interpolation operations may be conducted to a plurality of data frames in the second data segment 422 in order to generate negative samples with different sampling frequencies.

FIG. 4B shows a block diagram 400B of a process for determining the basic sample 210 and the negative sample 230 according to some implementations of the present disclosure. As shown in FIG. 4B, a data frame 440 may be selected from data sequences other than the second data sequence 420 of the plurality of data sequences 430. Here, the data frame 440 will be determined as an interferer, and noise may be added to the generated negative samples, thereby increasing the training difficulty and improving the accuracy of the contrastive learning model.

The data frame 440 can be selected based on various methods. For example, the data frame 440 can be randomly selected from other data sequences, a data frame at a specific location can be selected, or the data frame 440 can be selected based on contents of a data sequence. The negative sample 230 can be generated based on the second data segment 422 and the data frame 440. In other words, respective data frames in the second data segment 422 can be modified with the data frame 440, thereby generating the negative sample 230. In the case of video sequences, the appearance of a negative sample can be disturbed with video frames from other video sequences (for example, fusing the content of video frames into respective video frame in the negative sample, i.e., overlapping two video frames). Subsequently, the original video segment and the perturbed negative sample can be determined as a negative sample pair.

It will be understood that at this time, the negative sample is modified based on video frames from other video sequences, so more radical appearance perturbations can be introduced into the negative sample, thereby destroying an original information in the negative sample. The video frames from other video sequences usually have different color information, compared with a technical solution based solely on adjusting the sampling frequency of a video, a stronger perturbation can be introduced into a negative sample in terms of appearance, thereby providing a negative sample with richer semantic information. Different video frames can be determined as interference factors and a large number of negative samples can be generated. In this way, more negative samples with richer appearance information can be generated without a requirement to expand the training sample set, thereby improving an accuracy of the contrastive learning model.

According to an example implementation of the present disclosure, a noise data frame can be generated based on the data frame 440, and then each data frame in the second data segment 442 can be updated with the noise data frame. For example, the data frame 440 can be directly fused to each data frame in the second data segment 442 (i.e., the data frame 440 is superimposed on each data frame) to generate the negative sample 230. In this way, the data frame 440 will be directly fused to each video frame in the second data segment 422, and the negative sample can comprise richer semantic information, thereby improving the generalization ability of the contrastive learning model. Furthermore, the fusion process only involves simple processing and does not significantly increase the workload of generating negative samples. In this way, the negative sample can be generated in a simple and efficient way.

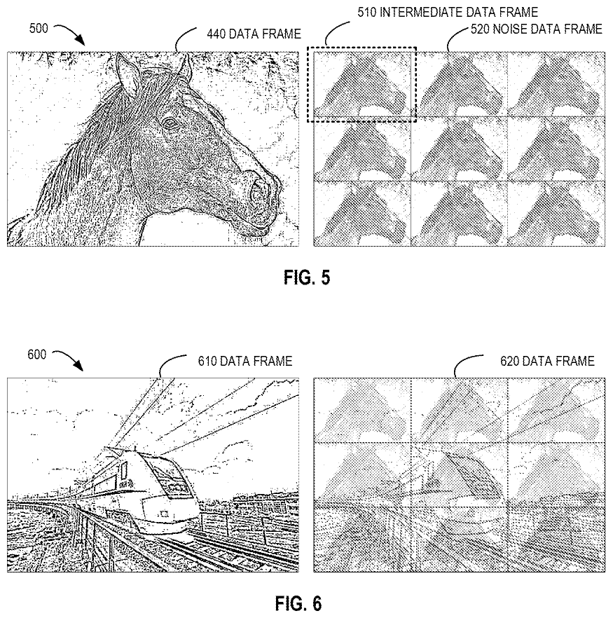

According to an example implementation of the present disclosure, in order to further enrich the appearance information of the negative sample, high-frequency information can be added to the negative sample 230. Specifically, high-frequency noise data frames can be generated based on the data frame 440, and respective data frames in the second data segment 422 can be updated by using the noise data frame. The process of generating a noise data frame is described in FIG. 5, which shows a block diagram 500 of the process for generating the noise data frame according to some implementations of the present disclosure.

As shown in FIG. 5, the data frame 440 represents a data frame used as interference data. Dimensions of the data frame 440 can be adjusted according to a predetermined ratio (for example, reducing a height and width of a video frame to 1/K of the original, for example K=3 or other values) to generate an intermediate data frame 510. The intermediate data frame 510 can be copied, and a plurality of copied intermediate data frames can be generated, and then the plurality of copied intermediate data frames can be joined to generate a noise data 520. At this time, the noise data frame 520 will comprise K*K reduced data frames.

It will be understood that although the adjustment of the same ratio is performed in both the height and width dimensions as shown above, alternatively and/or additionally, different adjustment methods can be performed. For example, only the ratio of the height dimension can be adjusted to generate noise data compressed by height. As another example, only the ratio of the width dimension can be adjusted to generate noise data compressed by width. As another example, the height dimension and the width dimension can be adjusted in different proportions to generate noise data frames with different scaling ratios in the height and width directions (for example, the ratio in the height direction is K1, and the ratio in the width direction is K2). It will be understood that although the above shows the case in which the noise data frame comprises intermediate images that are exactly an integer multiple, alternatively and/or additionally, the noise data can comprise intermediate images that are not integer multiples. For example, the noise data frame can comprise 6 complete intermediate data frames and 3 incomplete intermediate data frames.

In the following, how to generate the noise data frame 520 will be described with a specific formula. Assuming that a symbol X represents the data frame 440, adjustments can be conducted to the height and width dimensions of the data frame 440, so that the height H and width W of the data frame 440 are respectively adjusted to 1/K1 and 1/K2 of the original. At this time, the dimension of the intermediate data frame 510 is H/K1*W/K2. The K1*K2 copied intermediate data frames 510 can be joined to generate the noise data frame 520 of dimension H*W (represented by a symbol D).

Further, the noise data frame 520 may be fused to respective data frames in the second data segment 422, thereby generating the negative sample 230. FIG. 6 shows a block diagram 600 of a process for generating the data frame 520 in the negative sample 230 in accordance with some implementations of the present disclosure. As shown in FIG. 6, only a data frame 610 is described as an example of the data frame in the second data segment 422. The data frame 610 may be fused with the noise data frame 520 to generate a data frame 620 in the negative sample 230.

According to an example implementation of the present disclosure, each pixel in the data frame 620 can be determined one by one. For example, assuming that the second data segment 422 is represented by a symbol V′ᵢ and the j^{th} frame in the second data segment 422 is represented by a symbol V′(j), the data frame 620 in the negative sample 230 can be determined based on Formula 1.

$${\overline{V}}_{i}^{′} ( j ) = ( 1 - λ ) {V}_{i}^{′} ( j ) + λ D \qquad Formula 1$$

In Formula 1, the negative sample 230 is represented by V̅ᵢ, pixel data of the j^{th} frame in the negative sample 230 is represented by V̅′ᵢ(j), a predetermined weight of the noise data frame 520 is represented by λ, and pixel data of the noise data frame 520 is represented by D. Each data frame in the second data segment 422 can be processed based on Formula 1 to generate a data frame in the negative sample 230.

Specifically, a data value (e.g., a pixel value) of a given data point is obtained for which (e.g., a pixel at a position (x, y)) in the data frame 610 in the second data segment 422.

Subsequently, a corresponding data value of a data point corresponding to the given data point in the noise data frame 520 can be obtained. Further, a data value of a data point corresponding to the given data point in the data frame 620 can be determined based on the data value, the corresponding data value, and the weight of the noise data frame. In other words, the pixel value of the pixel at the position (x, y) in the synthesized data frame 620 can be determined based on the pixel value of the pixel at the position (x, y) in the data frame 610, the pixel value of the pixel at the position (x, y) in the noise data frame 520, and the weight.

It will be understood that the pixel values can comprise three channels of RGB (red, green, and blue), so the pixel values in each channel can be processed separately, and then the pixel values in each channel in the data frame 620 can be determined. Assuming that the three channels of RGB in the j^{th} frame are respectively represented by V′ᵢ^{R}(j), V′ᵢ^{G} (j), and V′ᵢ^{B}(j), the pixel values of respective channels of the j^{th} frame of the negative sample 230 can be determined based on Formula 2:

$${\overline{V}}_{i}^{′ R} ( j ) = ( 1 - λ ) {V}_{i}^{′ R} ( j ) + λ {D}^{R} \qquad Formula 2$$

$${\overline{V}}_{i}^{′ G} ( j ) = ( 1 - λ ) {V}_{i}^{′ G} ( j ) + λ {D}^{G}$$

$${\overline{V}}_{i}^{′ B} ( j ) = ( 1 - λ ) {V}_{i}^{′ B} ( j ) + λ {D}^{B}$$

In Formula 2, pixel data of the three channels of the j^{th} frame in the negative sample 230 is represented respectively by V′ᵢ^{R}(j), V′ᵢ^{G}(j), and V′ᵢ^{B}(j), the predetermined weight of the noise data frame 520 is represented by A, the pixel data of the three channels of the noise data frame 520 is represented respectively by D^{R}, D^{G}, and D^{B}. Each data frame in the second data segment 422 can be processed based on Formula 2 to generate a data frame in the negative sample 230.

According to an example implementation of the present disclosure, a weight A can be modified to adjust a degree of interference of the noise data frame 520 to respective data frames in the second data segment 422. Specifically, reducing the value of the weight A can add less noise, and increasing the value of the weight X can add more noise. A too-small weight A can only introduce a tiny noise, which may cause the generalization ability of the contrastive learning model insufficient. A too-large weight X will introduce a large amount of noise, which may cause the contrastive learning model to ignore dynamic information carried by an original data segment (i.e., an action change relationship between respective data frames), and then introduce uncertain factors into the contrastive learning model. A balance can be conducted between the above two aspects, and a suitable weight can be selected.

It will be understood that, although only the process of generating one negative sample is described in the foregoing, a plurality of negative samples may be generated in a similar way. Assuming that a data sequence collection comprises m data sequences, any one of the m data sequences may be determined as the first data sequence 410 described above, and any one of the remaining m−1 data sequences may be determined as the second data sequence 420 described above. The first data segment 412 may be determined from the first data sequence 410, and the second data segment 422 may be determined from the second data sequence 420, and the data frame 440 may be determined from other data sequences. Further, the negative sample 230 can be generated by updating the second data segment 422 with the data frame 440. In this way, a large number of negative samples may be generated to iteratively update the contrastive learning model, thereby allowing the model to gain more knowledge regarding the appearance of the samples.

The process of adding perturbation information to negative samples from different data sequences in order to generate the negative sample 230 has been described above. Alternatively and/or additionally, a sampling frequency of the data segment used as a negative sample can be adjusted so as to allow the contrastive learning model to more strongly perceive dynamic information in the sample. Specifically, a down-sampling (i.e., frame extraction) operation can be performed for the plurality of data frames in the negative sample 230. For example, data frames located at multiples of 2 (or other numbers) in the negative sample 230 can be discarded to generate a speed-adjusted negative sample. Alternatively and/or additionally, an up-sampling operation can be performed.

Compared with the original negative sample 230, dynamic changes of respective data frames in the speed-adjusted negative sample will be more significant, which can cause the contrastive learning model to perceive dynamic information in addition to the appearance information of the data frame, thereby enhancing the performance of the contrastive learning model. Specifically, in a video processing scenario, the speed-adjusted negative sample can be a video with a faster (or slower) playing speed, which causes the contrastive learning mode to better grasp dynamic changes between respective video frames.

According to an example implementation of the present disclosure, the process of adjusting the sampling frequency described above can be performed directly on data segments (e.g., the second data segment 422) from different data sequences. Alternatively and/or additionally, the process of adjusting the sampling frequency described above can be performed on interfered data segments (e.g., the negative sample 230 in FIG. 4B) from different data sequences. In this way, negative samples can comprise richer training data, thereby improving the training effect of the contrastive learning model.

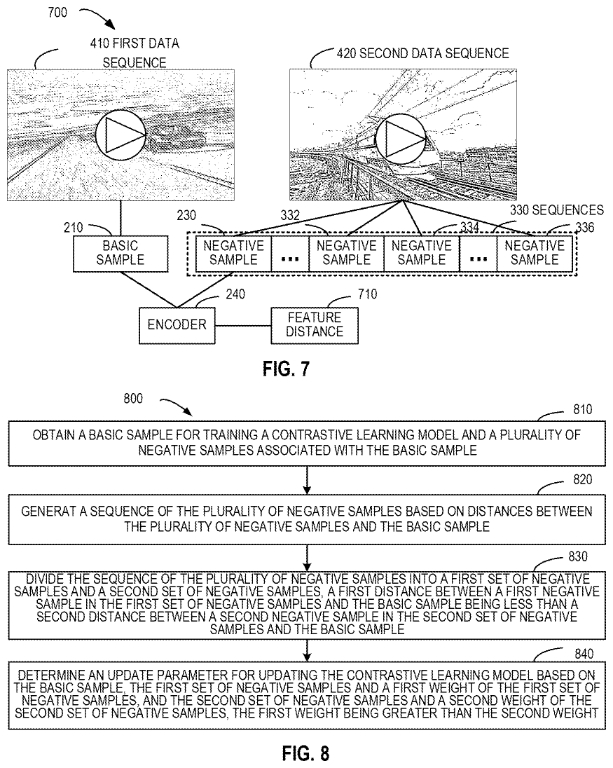

The process of determining the basic sample 210 and a plurality of negative samples from different data sequences has been described above. Further, a sequence of the plurality of negative samples may be determined based on the distance between the plurality of negative samples and the basic sample 210, the process of determining the sequence of negative samples is described with reference to FIG. 7. FIG. 7 shows a block diagram 700 of a process for determining a sequence of the plurality of negative samples based on a distance between samples according to some implementations of the present disclosure. As shown in FIG. 7, the basic sample 210 may be determined from the first data sequence 410, and a plurality of negative samples may be determined from the second data sequence 420. Features of respective negative samples and the basic sample 210 may be determined respectively with the encoder 240 in the contrastive learning model, and then a feature distance between the two features may be determined.

For example, the feature distance between the negative sample 230 and the basic sample 210 can be determined as a distance between the two samples 710. Distances between other negative samples and the basic samples 210 can be determined in a similar way and then sorted the distances in a way from small to large (or large to small) distances in order to form the sequence 330 of negative samples. At this time, the sequence 330 can comprise 230, . . . , 332, 334, . . . , 336.

According to an example implementation of the present disclosure, the number of the first set of negative samples 310 can be determined in advance. For example, k negative samples located at the head position in the sequence 330 can be selected, based on a predetermined number k, as the first set of negative samples. For another example, a proportion (e.g., 1% or other values) between the first set of negative samples 310 and all the plurality of negative samples can be determined in advance to select the predetermined proportion of negative samples at the head position in the sequence 330. Furthermore, other negative samples other than the first set of negative samples 310 can be used as the second set of negative samples 320. In this way, negative samples with different difficulties can be determined quickly and efficiently, thereby facilitating the performing of the training procedures with negative samples with different difficulties.

According to an example implementation of the present disclosure, a large weight (e.g., greater than 1) may be assigned to the first set of negative samples 310, and a small weight (e.g., equal to 1) may be assigned to the second set of negative samples 320. Further, when determining the update parameter (e.g., loss function) of the contrastive learning model, contribution of difficult negative samples can be increased, thereby improving an ability of the contrastive learning model to distinguish difficult negative samples.

According to an example implementation of the present disclosure, the update parameter for updating the contrastive learning model may be determined based on the basic sample 210, the first set of negative samples 310, and the first weight 312 of the first set of negative samples, and the second set of negative samples 320, and the second weight 322 of the second set of negative samples. Here, the first weight 312 is greater than the second weight 322. The method described above can be implemented on the basis of various loss functions currently known and/or to be developed in the future. It is assumed that the loss function of the contrastive learning model is determined based on Formula 3 in a conventional technical solution:

$$L = f ( {s}_{i} , {s}_{i}^{+} , s ) \qquad Formula 3$$

In Formula 3, specific values of the loss function are represented by L, features of the basic sample are represented by si, features of the positive sample are represented by sᵢ⁺, features of the negative sample are represented by s, and the loss function (for example, the loss function determined based on the infoNCE method) is represented by f. The loss function of the contrastive learning model can be determined based on Formula 4:

$$L = f ( {s}_{i} , {s}_{i}^{+} , {s}_{m} , {s}_{n} , α , γ ) \qquad Formula 4$$

In Formula 4, the first weight and the second weight are represented respectively by α and γ, the feature of negative samples in the first set of negative samples is represented by sₘ, the feature of negative samples in the second set of negative samples are represented by sₙ, and other symbols are same as Formula 3.

In the above formulas, the positive sample can be determined based on the following methods, and then feature sᵢ⁺ of the positive sample can be determined. A third data segment can be selected from the first data sequence 410 as a positive sample associated with the basic sample 210. Specifically, the third data segment can be selected from a position different from the basic sample 210 in the first data sequence 410. Alternatively and/or additionally, interference information can be added to the third data segment based on the method described above to increase the training difficulty and thus improve the performance of the contrastive learning model. Further, the update parameter can be determined based on the basic sample and the positive sample.

It will be understood that Formula 3 and Formula 4 described above are merely illustrative, alternatively and/or additionally, the loss function may further comprise a temperature parameter t, in which case Formula 4 may be rewritten as Formula 5:

$$L = f ( {s}_{i} , {s}_{i}^{+} , {s}_{m} , {s}_{n} , α , γ , t ) \qquad Formula 5$$

The process of using data segments from different data sequences as negative samples has been described above. Alternatively and/or additionally, negative samples can be selected from the data sequence where the basic sample 210 is located. Specifically, a fourth data segment is selected from the first data sequence 410. Further, a fifth data segment can be generated by adjusting a sampling frequency of a plurality of data frames in the fourth data segment in the way of frame extraction (and/or frame interpolation) described above. At this time, the fifth data segment is a negative sample (i.e., an inside-video negative sample) from the same data sequence as the basic sample.

It will be understood that although the above only schematically shows the process of generating one negative sample based on the same data sequence, the plurality of negative samples can be generated in a similar way. For example, the fifth data segment can be adjusted to different speeds to generate the plurality of negative samples. Noise can be added to negative samples based on the method described above to generate more negative samples. In this way, more dynamic changes can be introduced into negative samples, and the number of negative sample pairs can be further increased and the recognition ability of the contrastive learning model can be improved.

According to an example implementation of the present disclosure, the plurality of negative samples from the same data sequence can be used to generate a third set of negative samples, and a third weight can be assigned to the third set of negative samples. It will be understood that the third set of negative samples comes from the same data sequence as the basic sample 210, so the third set of negative samples is more difficult to identify compared to negative samples from different data sequences. In this case, the third weight can be greater than the second weight in order to improve the contribution of difficult negative samples in the third set of negative samples to the contrastive learning model. In this case, Formula 4 can be rewritten as Formula 6:

$$L = f ( {s}_{i} , {s}_{i}^{+} , {s}_{l} , {s}_{m} , {s}_{n} , {α}_{1} , {α}_{2} , γ ) \qquad Formula 6$$

In Formula 6, a feature of the third set of negative samples from the same data sequence is represented by sᵢ, and weights for the third set of negative samples, the first set of negative samples, and the second set of negative samples are respectively represented by α₁, α₂, and γ. For example, α₁ and α₂ can have values greater than 1 (both can be set to the same or different values), and y can be equal to 1.

In the following, further details will be provided regarding determining the loss function. According to an example implementation of the present disclosure, based on the infoNCE algorithm, Formula 6 can be refined into Formula 7:

$$L = - {\sum }_{i} log \frac{exp ( {s}_{i}^{T} {s}_{i}^{+} )}{\begin{matrix}exp ( {s}_{i}^{T} {s}_{i}^{+} ) + {α}_{1} {\sum }_{l ∈ {S}_{intra}} exp ( {s}_{i}^{T} {s}_{l} ) + \\ {α}_{2} {\sum }_{m ∈ {S}_{topk}} exp ( {s}_{i}^{T} {s}_{m} ) + γ {\sum }_{n ∈ {S}_{inter} - {S}_{topk}} exp ( {s}_{i}^{T} {s}_{n} )\end{matrix}} \qquad Formula 7$$

According to an example implementation of the present disclosure, respective samples can be obtained separately from the plurality of data sequences, and then the features of respective samples can be determined with an encoder in the contrastive learning model. In the context of the present disclosure, samples can be represented by a symbol V, and corresponding features of the samples can be represented by a symbol s. Refer to Tables 1 and 2 for a specific meaning of data segments as samples. Table 1 below shows a plurality of data segments from the same data sequence in symbols, and Table 2 below shows a plurality of data segments from different data sequences in symbols.

TABLE 1
Data segments from data segment i

| Number | Symbol | Description |
|---|---|---|
| 1 | Vᵢ | A data segment in the data sequence i |
| 2 | Vᵢ′ | Another data segment in the data sequence i |
| 3 | Vᵢ⁺ | A fused positive sample, i.e., a positive |
| | | sample obtained after adding perturbation |
| | | information to the data segment Vᵢ |
| 4 | Vᵢ₍ₘₒₜᵢₒₙ₎⁻ | A negative sample obtained after adjusting a |
| | | sampling frequency of the data segment Vᵢ′, |
| | | i.e., a speed-adjusted negative sample |
| 5 | V_{i(masked+motion)}⁻ | A negative sample obtained after adjusting a |
| | | sampling frequency of the data segment Vᵢ⁺, |
| | | i.e., a fused and speed-adjusted negative |
| | | sample |

TABLE 2
Data segments from data segment j

| Number | Symbol | Description |
|---|---|---|
| 1 | V_{j≠i} | A data segment from the data sequence j |
| 2 | V_{j≠i}⁺ | A fused data segment from the data |
| | | sequence j |
| 3 | V_{j≠i(motion)}− | A speed-adjusted data segment from the |
| | | data sequence j |
| 4 | V_{j≠i(masked+motion)}⁻ | A fused and speed-adjusted data segment |
| | | from the data sequence j |

According to an example implementation of the present disclosure, the positive sample can comprise Vᵢ⁺. The negative sample can comprise data segments Vᵢₙₜᵣₐ (Vᵢ₍ₘₒₜᵢₒₙ₎⁺ and V_{i(masked+motion)}⁻) from the same data sequence. In other words, the data segments from the same data sequence can be used as negative samples after a speed-adjusted operation. Alternatively and/or additionally, the negative sample can also comprise data segments Vᵢₙₜₑᵣ from different data sequences (comprising V_{j≠i}, V_{j≠i}⁺, V_{j≠i(motion)}⁺, and V_{j≠i(masked+motion)}⁺). In other words, data segments from different data sequences can be used as negative samples, and in order to improve information richness of negative samples, image fusion, speed adjusting, or image fusion and speed adjusting can be performed for data segments from different data sequences.

According to an example implementation of the present disclosure, the first set of negative samples, the second set of negative samples, and the third set of negative samples described above can be determined with the respective data segment shown above. At this time, the first set of negative samples can comprise k negative samples ranked near the head of the sequence in Vᵢₙₜₑᵣ (e.g., represented by Vₜₒₚₖ, and a corresponding feature set can be represented by Sₜₒₚₖ). The second set of negative samples can comprise negative samples other than Vₜₒₚₖ in Vᵢₙₜₑᵣ (i.e., Vᵢₙₜₑᵣ₋ₜₒₚk), and a corresponding feature set can be represented by Sᵢₙₜₑᵣ₋ₜₒₚₖ. The third set of negative samples can comprise Vᵢₙₜᵣₐ and a corresponding feature set can be represented by Sᵢₙₜᵣₐ.

Furthermore, the loss function can be determined with the formula described above, and then the contrastive learning model can be trained. According to an example implementation of the present disclosure, positive and negative samples can be constructed based on the method described above in a plurality of training phases, and then the loss function can be determined based on Formula 3-7 described above, and the contrastive learning model can be updated towards minimizing the loss function. In this way, positive sample pairs can narrow the features between positive samples, and negative sample pairs can push the features between negative samples far away, thereby improving the accuracy of the contrastive learning model.

It will be understood that although the training process has only been described with the video sequences as examples of the data sequences, alternatively and/or additionally, the data sequences may also comprise sequences for example an audio sequence, thermal image sequence, temperature sequence, humidity sequence, or other monitored parameters. Specifically, in the case of processing the audio data, the audio data can be sampled at a predetermined frequency and an audio data sequence at a predetermined sampling point can be generated. The audio data sequence can be processed in the way described above to generate corresponding positive and negative sample pairs, and then perform a two-phase training process.

According to an example implementation of the present disclosure, by setting different weights for negative samples with different difficulties, the contrastive learning model can learn more semantic knowledge in difficult negative samples. In this way, the training efficiency of the contrastive learning model can be improved, and the accuracy of the contrastive learning model can be improved.

### Model Application Process

According to an example implementation of the present disclosure, after the two-phase training process has been performed with the method described above, an association between two data segments in the sample pair to be processed can be determined with an updated contrastive learning model. Here, the sample pair to be processed can comprise the first data segment and the second data segment. In the case of video processing, the first data segment and the second data segment can be two video segments, and the contrastive learning model can determine whether the two video segments are consistent. Since the second contrastive learning model already has knowledge of both the appearance and the dynamics of videos, the consistency between the two data segments can be determined in a more accurate and reliable way.

According to an example implementation of the present disclosure, the effect of training the contrastive learning model with the provided technical solution can be verified under a plurality of public datasets. Table 3 below shows evaluation results in downstream scenarios using a full fine-tuning and linear evaluation. Here, the full fine-tuning and linear evaluation are two forms used for downstream task training, wherein the full fine-tuning means that trained model parameters directly participate in a full-parameter fine-tuning training in downstream tasks, and the linear evaluation represents that only a last fully connected layer is adjusted, and other parameters are fixed.

TABLE 3
Accuracy of an obtained contrastive learning model using
the training process of the present disclosure

| | | FULL FINE-TUNING | | LINEAR EVALUATION | |
|---|---|---|---|---|---|
| β | α | UCF | HMDB | UCF | HMDB |
| 0 | 0 | 80.9 | 51.0 | 73.9 | 40.3 |
| 0.01 | 1.5 | 81.7 | 52.3 | 74.9 | 41.4 |
| 0.01 | 2.0 | 81.6 | 51.6 | 74.8 | 41.6 |
| 0.01 | 3.0 | 80.9 | 50.8 | 74.2 | 41.0 |
| 0.05 | 1.5 | 79.3 | 49.7 | 72.7 | 40.3 |

In Table 3, UCF and HMDB represent different datasets. The first row in Table 3 shows an accuracy of the obtained contrastive learning model using conventional technical solutions. Rows 2 to 4 in Table 3 show that when β (i.e., a ratio of the first set of negative samples to all negative samples from different data sequences) and α (in this case, α₁=α₂ and γ=1) are set to different values, the contrastive learning model can have different accuracy rates. From Table 3, the accuracy of the contrastive learning model can be improved with the training method according to an example implementation of the present disclosure. On different datasets, the specific values of β and α can be set based on the experimental results shown in Table 3 to further improve the accuracy of the contrastive learning model.

### Example Process

The specific process of generating samples has been described above. Hereinafter, a corresponding method is described with reference to FIG. 8. FIG. 8 shows a flowchart of a method 800 for managing models based on a distance between samples according to some implementations of the present disclosure. As shown in FIG. 8, at block 810, a basic sample for training a contrastive learning model and a plurality of negative samples associated with the basic sample is obtained; at block 820, a sequence of the plurality of negative samples is generated based on distances between the plurality of negative samples and the basic sample; at block 830, the sequence of the plurality of negative samples is divided into a first set of negative samples and a second set of negative samples, a first distance between a first negative sample in the first set of negative samples and the basic sample is less than a second distance between a second negative sample in the second set of negative samples and the basic sample; and at block 840, an update parameter for updating the contrastive learning model is determined based on the basic sample, the first set of negative samples and a first weight of the first set of negative samples, and the second set of negative samples and a second weight of the second set of negative samples, the first weight is greater than the second weight.

According to an example implementation of the present disclosure, obtaining the basic sample and the plurality of negative samples comprises: selecting, from a first data sequence of a plurality of data sequences for training the contrastive learning model, a first data segment as the basic sample; and selecting, from a second sequence of the plurality of data sequences, a second data segment as a negative sample of the plurality of negative samples.

According to an example implementation of the present disclosure, the method 800 further comprises: selecting a third data segment from the first data sequence as a positive sample associated with the basic sample; and wherein determining the update parameter further comprises: determining the update parameter based on the basic sample and the positive sample.

According to an example implementation of the present disclosure, the method 800 further comprises: selecting a fourth data segment from the first data sequence; adjusting a sampling frequency of a plurality of data frames in the fourth data segment to generate a fifth data segment; generating a third set of negative samples for training the contrastive learning model based on the fifth data segment; and wherein determining the update parameter further comprises: determining the update parameter based on the third set of negative samples and a third weight of the third set of negative samples, the third weight being greater than the second weight.

According to an example implementation of the present disclosure, the method 800 further comprises: generating the negative sample by updating at least one of an appearance and a sampling frequency of a plurality of data frames of the second data segment.

According to an example implementation of the present disclosure, generating the negative sample comprises: selecting a data frame from a data sequence other than the second data sequence in the plurality of data sequences; and generating the negative sample by updating an appearance of the second data segment with the data frame.

According to an example implementation of the present disclosure, generating the negative sample by updating an appearance of the second data segment with the data frame comprises: generating a noise data frame based on the data frame; and updating a data frame of the second data segment with the noise data frame.

According to an example implementation of the present disclosure, generating the noise data frame comprises: generating an intermediate data frame by adjusting a dimension of the data frame based on a predetermined ratio; generating a plurality of copied intermediate data frames by copying the intermediate data frame; and generating the noise data by joining the plurality of copied intermediate data frames.

According to an example implementation of the present disclosure, generating the negative sample comprises: generating the negative sample by adjusting the sampling frequency of the plurality of data frames of the second data segment.

According to an example implementation of the present disclosure, dividing the sequence comprises dividing the sequence based on at least any of: the number of the first set of negative samples, a ratio of the first set of negative samples to the plurality of negative samples.

According to an example implementation of the present disclosure, the method 900 further comprises: updating the contrastive learning model with the update function.

According to an example implementation of the present disclosure, the method 900 further comprises: determining an association between a first data segment and a second data segment of a pair of samples to be processed with an updated contrastive learning model.

### Example Apparatus and Equipment

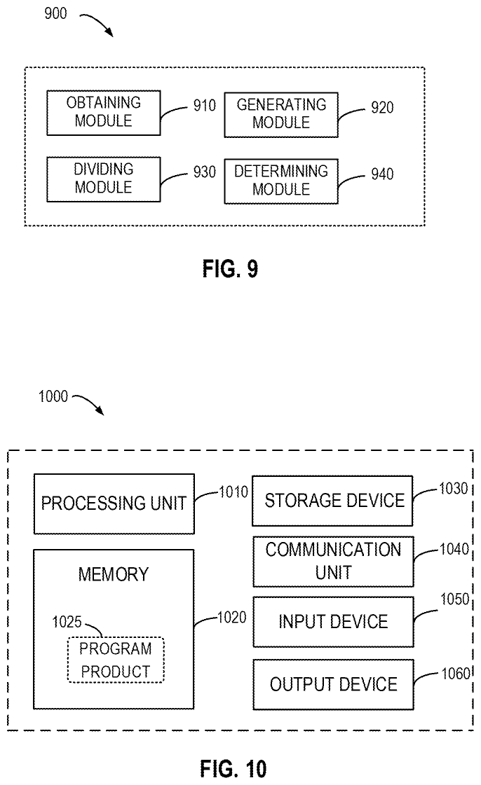

FIG. 9 shows a block diagram of an apparatus 900 for managing models based on a distance between samples according to some implementations of the present disclosure. The apparatus 900 comprises: an obtaining module 910, configured to obtain a basic sample for training a contrastive learning model and a plurality of negative samples associated with the basic sample; a generating module 920, configured to generate a sequence of the plurality of negative samples based on a distance between the plurality of negative samples and the basic sample; a dividing module 930, configured to divide the sequence of the plurality of negative samples into a first set of negative samples and a second set of negative samples, a first distance between a first negative sample in the first set of negative samples and the basic sample being less than a second distance between a second negative sample in the second set of negative samples and the basic sample; and a determining module 940, configured to determine an update parameter for updating the contrastive learning model based on the basic sample, the first set of negative samples and a first weight of the first set of negative samples, and the second set of negative samples and a second weight of the second set of negative samples, the first weight being greater than the second weight.

According to an example implementation of the present disclosure, the obtaining module 910 comprises: a first selection module configured to select, from a first data sequence of a plurality of data sequences for training the contrastive learning model, a first data segment as the basic sample; and a second selection module configured to select, from a second sequence of the plurality of data sequences, a second data segment as a negative sample of the plurality of negative samples.

According to an example implementation of the present disclosure, the apparatus 900 further comprises: a third selection module configured to select a third data segment from the first data sequence as a positive sample associated with the basic sample; and wherein the determining module is further configured to: determine the update parameter based on the basic sample and the positive sample.

According to an example implementation of the present disclosure, the apparatus 900 further comprises: a fourth selection module configured to select a fourth data segment from the first data sequence; an adjustment module configured to adjust a sampling frequency of a plurality of data frames in the fourth data segment to generate a fifth data segment; and a negative sample generation module configured to generate a third set of negative samples for training the contrastive learning model based on the fifth data segment, the determining module further configured to: determine the update parameter based on the third set of negative samples and a third weight of the third set of negative samples, the third weight being greater than the second weight.

According to an example implementation of the present disclosure, the apparatus 900 further comprises: an updating module configured to generate the negative sample by updating at least one of an appearance and a sampling frequency of a plurality of data frames of the second data segment.

According to an example implementation of the present disclosure, the negative sample generation module comprises: a data frame selection module configured to select a data frame from a data sequence other than the second data sequence in the plurality of data sequences; and an appearance updating module configured to generate the negative sample by updating an appearance of the second data segment with the data frame.

According to an example implementation of the present disclosure, the appearance updating module comprises: a noise generation module configured to generate a noise data frame based on the data frame; and a data frame updating module configured to update a data frame of the second data segment with the noise data frame.

According to an example implementation of the present disclosure, the noise generation module comprises: an intermediate data frame generation module configured to generate an intermediate data frame by adjusting a dimension of the data frame based on a predetermined ratio; a replication module configured to generate a plurality of copied intermediate data frames by copying the intermediate data frame; and a joining module configured to generate the noise data by joining the plurality of copied intermediate data frames.

According to an example implementation of the present disclosure, the negative sample generation module further comprises: a frequency adjustment module configured to generate the negative sample by adjusting the sampling frequency of the plurality of data frames of the second data segment.

According to an example implementation of the present disclosure, the dividing module is configured to divide the sequence based on at least any of: the number of the first set of negative samples, a ratio of the first set of negative samples to the plurality of negative samples.

According to an example implementation of the present disclosure, the apparatus 900 further comprises: determining an association between a first data segment and a second data segment of a pair of samples to be processed with an updated contrastive learning model.

According to an example implementation of the present disclosure, the apparatus 900 further comprises: using the updated contrastive learning model to determine the association between the first data segment and the second data segment in the sample pair to be processed.

FIG. 10 shows an electronic device 1000 in which one or more implementations of the present disclosure may be implemented. It would be understood that the electronic device 1000 shown in FIG. 10 is only an example and should not constitute any restriction on the function and scope of the implementations described herein.

As shown in FIG. 10, the electronic device 1000 is in the form of a general computing device. The components of the electronic device 1000 may comprise but are not limited to, one or more processors or processing units 1010, a memory 1020, a storage device 1030, one or more communication units 1040, one or more input devices 1050, and one or more output devices 1060. The processing unit 1010 may be an actual or virtual processor and can execute various processes according to the programs stored in the memory 1020. In a multiprocessor system, a plurality of processing units execute computer executable instructions in parallel to improve the parallel processing capability of the electronic device 1000.

The electronic device 1000 typically comprises a variety of computer storage medium. Such medium may be any available medium that is accessible to the electronic device 1000, comprising but not limited to volatile and non-volatile medium, removable, and non-removable medium. The memory 1020 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 1030 may be any removable or non-removable medium and may comprise a machine-readable medium, such as a flash drive, a disk, or any other medium, which can be used to store information and/or data (such as training data for training) and can be accessed within the electronic device 1000.

The electronic device 1000 may further comprise additional removable/non-removable, volatile/non-volatile storage medium. Although not shown in FIG. 10, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 1020 may comprise a computer program product 1025, which has one or more program modules configured to perform various methods or acts of various implementations of the present disclosure.

The communication unit 1040 communicates with a further computing device through the communication medium. In addition, functions of components in the electronic device 1000 may be implemented by a single computing cluster or a plurality of computing machines, which can communicate through a communication connection. Therefore, the electronic device 1000 may be operated in a networking environment using a logical connection with one or more other servers, a network personal computer (PC), or another network node.

The input device 1050 may be one or more input devices, such as a mouse, a keyboard, a trackball, etc. The output device 1060 may be one or more output devices, such as a display, a speaker, a printer, etc. The electronic device 1000 may also communicate with one or more external devices (not shown) through the communication unit 1040 as required. The external device, such as a storage device, a display device, etc., communicates with one or more devices that enable users to interact with the electronic device 1000, or communicate with any device (for example, a network card, a modem, etc.) that makes the electronic device 1000 communicate with one or more other computing devices. Such communication may be executed via an input/output (I/O) interface (not shown).

According to the example implementation of the present disclosure, a computer-readable storage medium is provided, on which a computer-executable instruction or computer program is stored, wherein the computer-executable instructions or the computer program is executed by the processor to implement the method described above.

According to the example implementation of the present disclosure, a computer program product is also provided. The computer program product is physically stored on a non-transient computer-readable medium and comprises computer-executable instructions, which are executed by the processor to implement the method described above.

Various aspects of the present disclosure are described herein with reference to the flow chart and/or the block diagram of the method, the device, the equipment, and the computer program product implemented in accordance with the present disclosure. It would be understood that each block of the flowchart and/or the block diagram and the combination of respective blocks in the flowchart and/or the block diagram may be implemented by computer-readable program instructions.

These computer-readable program instructions may be provided to the processing units of general-purpose computers, special computers, or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device, and/or other devices to work in a specific way. Therefore, the computer-readable medium containing the instructions comprises a product, which comprises instructions to implement various aspects of the functions/acts specified in one or more blocks in the flowchart and/or the block diagram.

The computer-readable program instructions may be loaded onto a computer, other programmable data processing apparatus, or other devices, so that a segment of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions, and operations of the system, the method, and the computer program product implemented in accordance with the present disclosure. In this regard, each block in the flowchart or the block diagram may represent a part of a module, a program segment, or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Respective implementation of the present disclosure has been described above. The above description is exemplary, not exhaustive, and is not limited to the disclosed implementations. Without departing from the scope and spirit of the described implementations, many modifications and changes are obvious to ordinary skill in the art. The selection of terms used in this article aims to best explain the principles, practical application, or improvement of technology in the market of respective implementation, or to enable other ordinary skills in the art to understand the various implementations disclosed herein.

I/We claim:

1. A method for managing a model based on a distance between samples, comprising:
obtaining a basic sample for training a contrastive learning model and a plurality of negative samples associated with the basic sample;
generating a sequence of the plurality of negative samples based on distances between the plurality of negative samples and the basic sample;
dividing the sequence of the plurality of negative samples into a first set of negative samples and a second set of negative samples, a first distance between a first negative sample in the first set of negative samples and the basic sample being less than a second distance between a second negative sample in the second set of negative samples and the basic sample; and
determining an update parameter for updating the contrastive learning model based on the basic sample, the first set of negative samples and a first weight of the first set of negative samples, and the second set of negative samples and a second weight of the second set of negative samples, the first weight being greater than the second weight.

2. The method of claim 1, wherein obtaining the basic sample and the plurality of negative samples comprises:
selecting, from a first data sequence of a plurality of data sequences for training the contrastive learning model, a first data segment as the basic sample; and
selecting, from a second sequence of the plurality of data sequences, a second data segment as a negative sample of the plurality of negative samples.

3. The method of claim 2, further comprising: selecting a third data segment from the first data sequence as a positive sample associated with the basic sample; and
wherein determining the update parameter further comprises: determining the update parameter based on the basic sample and the positive sample.

4. The method of claim 2, further comprising:
selecting a fourth data segment from the first data sequence;
adjusting a sampling frequency of a plurality of data frames in the fourth data segment to generate a fifth data segment;
generating a third set of negative samples for training the contrastive learning model based on the fifth data segment; and
wherein determining the update parameter further comprises: determining the update parameter based on the third set of negative samples and a third weight of the third set of negative samples, the third weight being greater than the second weight.

5. The method of claim 2, further comprising: generating the negative sample by updating at least one of an appearance and a sampling frequency of a plurality of data frames of the second data segment.

6. The method of claim 5, wherein generating the negative sample comprises:
selecting a data frame from a data sequence other than the second data sequence in the plurality of data sequences; and
generating the negative sample by updating an appearance of the second data segment with the data frame.

7. The method of claim 6, wherein generating the negative sample by updating an appearance of the second data segment with the data frame comprises:
generating a noise data frame based on the data frame; and
updating a data frame of the second data segment with the noise data frame.

8. The method of claim 7, wherein generating the noise data frame comprises:
generating an intermediate data frame by adjusting a dimension of the data frame based on a predetermined ratio.
generating a plurality of copied intermediate data frames by copying the intermediate data frame; and
generating the noise data by joining the plurality of copied intermediate data frames.

9. The method of claim 5, wherein generating the negative sample comprises: generating the negative sample by adjusting the sampling frequency of the plurality of data frames of the second data segment.

10. The method of claim 1, wherein dividing the sequence comprises dividing the sequence based on at least any of: the number of the first set of negative samples, a ratio of the first set of negative samples to the plurality of negative samples.

11. The method of claim 1, further comprising: updating the contrastive learning model with the update function.

12. The method of claim 11, further comprising: determining an association between a first data segment and a second data segment of a pair of samples to be processed with an updated contrastive learning model.

13. An electronic device, comprising:
at least one processing unit; and
at least one memory coupled to the at least one processing unit and storing instructions to be executed by the at least one processing unit, the instructions, when executed by the at least one processing unit, causing the electronic device to perform a method for managing a model based on a distance between samples, the method comprising:
obtaining a basic sample for training a contrastive learning model and a plurality of negative samples associated with the basic sample;
generating a sequence of the plurality of negative samples based on distances between the plurality of negative samples and the basic sample;
dividing the sequence of the plurality of negative samples into a first set of negative samples and a second set of negative samples, a first distance between a first negative sample in the first set of negative samples and the basic sample being less than a second distance between a second negative sample in the second set of negative samples and the basic sample; and
determining an update parameter for updating the contrastive learning model based on the basic sample, the first set of negative samples and a first weight of the first set of negative samples, and the second set of negative samples and a second weight of the second set of negative samples, the first weight being greater than the second weight.

14. The device of claim 13, wherein obtaining the basic sample and the plurality of negative samples comprises:
selecting, from a first data sequence of a plurality of data sequences for training the contrastive learning model, a first data segment as the basic sample; and
selecting, from a second sequence of the plurality of data sequences, a second data segment as a negative sample of the plurality of negative samples.

15. The device of claim 14, further comprising: selecting a third data segment from the first data sequence as a positive sample associated with the basic sample; and
wherein determining the update parameter further comprises: determining the update parameter based on the basic sample and the positive sample.

16. The device of claim 14, further comprising:
selecting a fourth data segment from the first data sequence;
adjusting a sampling frequency of a plurality of data frames in the fourth data segment to generate a fifth data segment;
generating a third set of negative samples for training the contrastive learning model based on the fifth data segment; and
wherein determining the update parameter further comprises: determining the update parameter based on the third set of negative samples and a third weight of the third set of negative samples, the third weight being greater than the second weight.

17. The device of claim 14, further comprising: generating the negative sample by updating at least one of an appearance and a sampling frequency of a plurality of data frames of the second data segment.

18. The device of claim 17, wherein generating the negative sample comprises:
selecting a data frame from a data sequence other than the second data sequence in the plurality of data sequences; and
generating the negative sample by updating an appearance of the second data segment with the data frame.

19. The device of claim 18, wherein generating the negative sample by updating an appearance of the second data segment with the data frame comprises:
generating a noise data frame based on the data frame; and
updating a data frame of the second data segment with the noise data frame.

20. A non-transitory computer-readable storage medium having a computer program stored thereon, the computer program, when executed by a processor, implementing a method for managing a model based on a distance between samples, the method comprising:
obtaining a basic sample for training a contrastive learning model and a plurality of negative samples associated with the basic sample;
generating a sequence of the plurality of negative samples based on distances between the plurality of negative samples and the basic sample;
dividing the sequence of the plurality of negative samples into a first set of negative samples and a second set of negative samples, a first distance between a first negative sample in the first set of negative samples and the basic sample being less than a second distance between a second negative sample in the second set of negative samples and the basic sample; and
determining an update parameter for updating the contrastive learning model based on the basic sample, the first set of negative samples and a first weight of the first set of negative samples, and the second set of negative samples and a second weight of the second set of negative samples, the first weight being greater than the second weight.
